(19) United States
(12) Patent Application Publication
(10) Pub. No.: US 2023/0016202 A1
(43) Pub. Date: Jan. 19, 2023

(54) CONTROL SWITCH MOUNT STRUCTURE OF STRADDLING FASHION VEHICLE

(71) Applicant: KWANG YANG MOTOR CO., LTD., KAOHSIUNG CITY (TW)

(72) Inventor: YUH-CHYI KUO, KAOHSIUNG CITY (TW)

(21) Appl. No.: 17/744,758

(22) Filed: May 16, 2022

(30) Foreign Application Priority Data
Jul. 16, 2021 (TW) 110127009

(51) Int. Cl. B62K 11/14; B62H 5/06

(52) U.S. Cl. CPC B62K 11/14; B62H 5/06

(57) ABSTRACT

A control switch mount structure of a straddling fashion vehicle is provided. A front end of a vehicle frame unit of a vehicle is provided with a support member. The support member is provided with a steering handlebar. Two sides of the steering handlebar are each provided with a primary switch mount. An outer periphery of the vehicle frame unit is provided with and covered by a vehicle-body cover unit. The vehicle-body cover unit at least includes a knee-shielding hood. The knee-shielding hood of the support member that is arranged toward a vehicle body rear side is provided with a secondary switch mount. The secondary switch mount includes multiple switch control buttons and multiple trigger switches that are triggerable by the switch control buttons. As such, a control item for a change of a non-vehicle-operating state of the vehicle is controlled to thereby enhance operation performance of the vehicle.

### TECHNICAL FIELD OF THE INVENTION

The present invention relates generally to a control switch mount structure of a straddling fashion vehicle, and more particularly to a straddling-fashion-vehicle control switch mount structure that is operable to control a control item for changing a non-operating state of a vehicle so as to enhance vehicle operation performance.

### DESCRIPTION OF THE PRIOR ART

As shown in FIG. 1, for a dual-front-wheel straddling fashion vehicle, to allow an operator to change a vehicle operating state or to provide an indication of a vehicle operating state, switch mounts 12 are arranged at two ends of a steering handlebar 11 of a vehicle 1. The switch mounts 12 are provided with a plurality of switches that are operable to control a change of a vehicle operating state or to provide an indication for a vehicle operating state, such as a headlight control switch for controlling front-side lighting of the vehicle 1, a directional sign control switch for indication of left/right turning of the vehicle 1, a starter motor control switch for starting of the vehicle 1, a horn switch for warning other vehicles or pedestrians. Arranging the control switch mounts 12 on the steering handlebar 11 makes it easy for an operator to operate the control switches provided on the switch mounts 12 during vehicle running, so as to ease the operator's change of a vehicle operating state or providing an indication for a change of a vehicle operating state.

However, to provide an operator with a more convenient and safer vehicle operating state, the vehicle 1 is provided with an increased number of control items for vehicle operating, such as a control of seat cushion lock and a control for switching displayed contents on a dashboard. With the increase of the vehicle-operating control items, the switch mount 12 becomes lacking of a sufficient space for mounting other control switches. Thus, it becomes a challenge for the straddling fashion vehicle manufacturers to provide other switch mounts for control switches of non-operating states.

### SUMMARY OF THE INVENTION

The primary objective of the present invention is to provide a control switch mount structure of a straddling fashion vehicle so as to enhance easiness of operation for a control item for a change of a non-operating state of the vehicle.

For such a purpose, the primary technical solution of the present invention provides a control switch mount structure of a straddling fashion vehicle. A front end of a vehicle frame unit of the vehicle is provided with a support member. The support member is provided with a steering handlebar. Two sides of the steering handlebar are each provided with a primary switch mount. An outer periphery of the vehicle frame unit is provided with and covered by a vehicle-body cover unit. The vehicle-body cover unit at least comprises a knee-shielding hood. The knee-shielding hood of the support member that is arranged toward a vehicle body rear side is provided with a secondary switch mount. The secondary switch mount comprises a plurality of switch control buttons and a plurality of trigger switches that are triggerable by the switch control buttons.

Efficacy that some technical solutions adopted in the present invention may achieve is that a control item for a change of a non-operating state of a vehicle may be controlled to enhance operation performance of the vehicle.

### BRIEF DESCRIPTION OF THE DRAWINGS

FIG. 1 is a schematic view of a known vehicle steering handlebar.

FIG. 2 is a perspective view of a vehicle according to the present invention.

FIG. 3 is a side elevational view of the vehicle according to the present invention.

FIG. 4 is a front view of the vehicle according to the present invention, with a vehicle-body cover removed.

FIG. 5 is a schematic view illustrating arrangement of secondary switch mount according to the present invention.

FIG. 6 is a schematic view illustrating a front portion of the vehicle according to the present invention, with the vehicle-body cover removed.

FIG. 7 is an exploded view of the secondary switch mount according to the present invention.

FIG. 8 is a schematic view illustrating the second switch mount arranged on a knee-shielding hood according to the present invention.

FIGS. 9 and 10 are schematic views demonstrating an operation of the secondary switch mount according to the present invention.

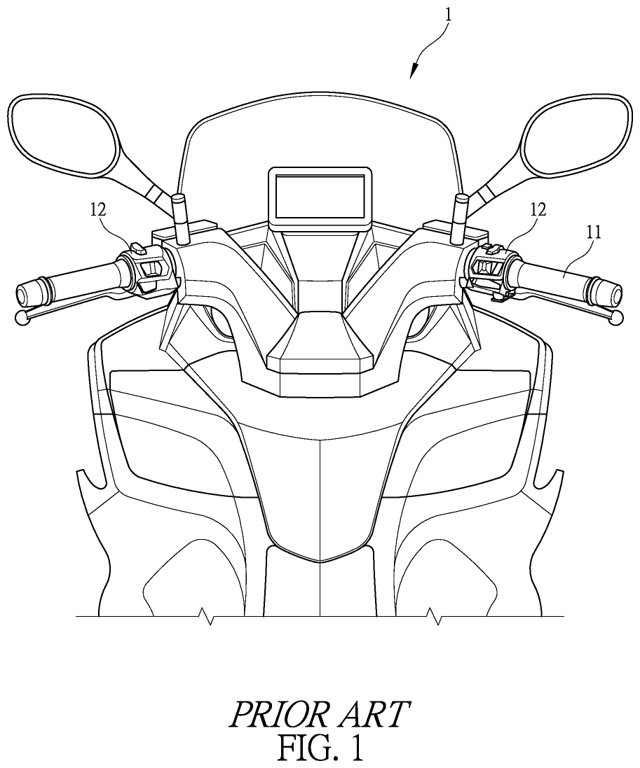

### DETAILED DESCRIPTION OF THE PREFERRED EMBODIMENT

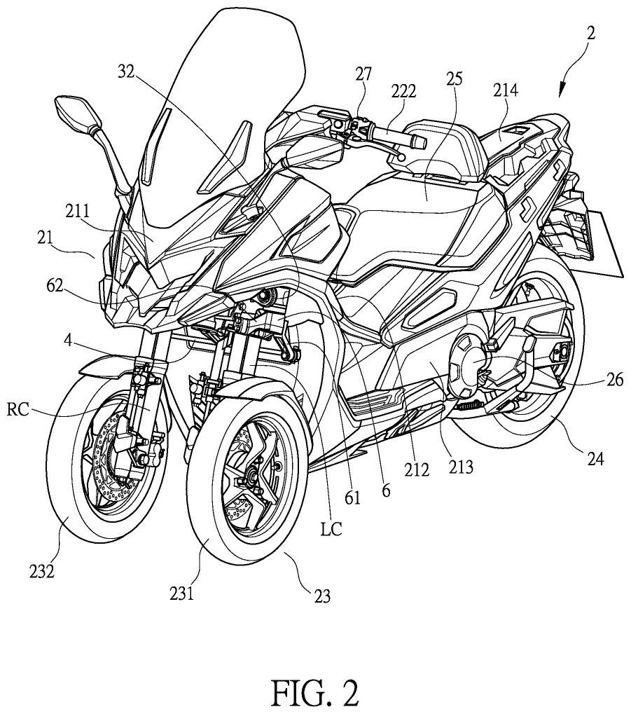

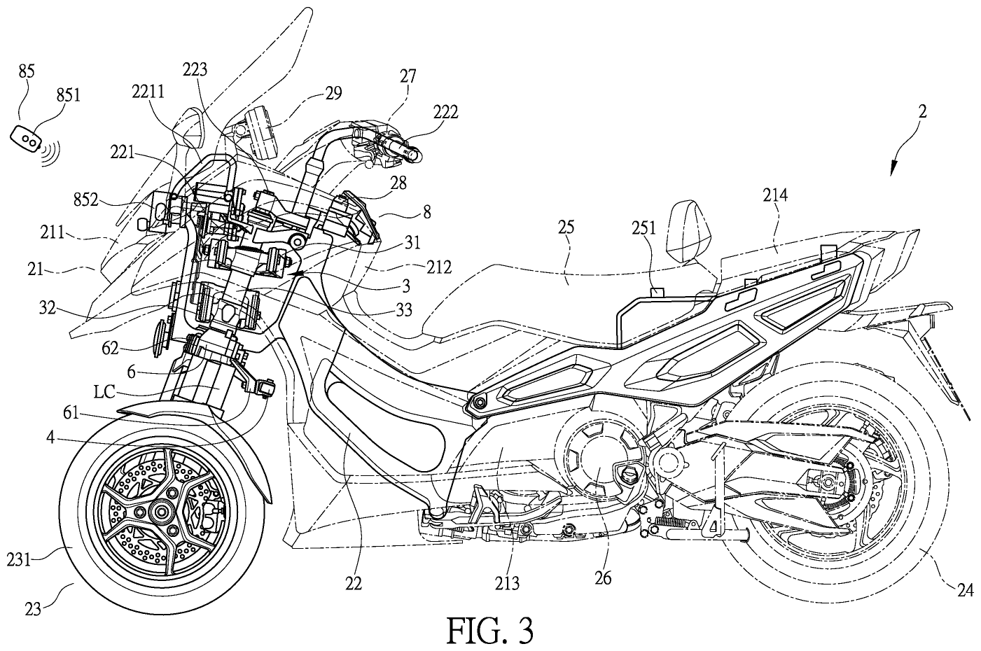

As shown in FIGS. 2 and 3, the present invention provides a straddling fashion vehicle, which is particularly a straddling vehicle having two wheels on the front and one wheel on the rear. The vehicle 2 at least comprises a vehicle-body cover unit 21, a vehicle frame unit 22 covered by the vehicle-body cover unit 21, front wheels 23 arranged pairwise as a left one and a right one on a front side of the vehicle frame unit 22, a rear wheel 24 arranged on a rear side of the vehicle frame unit 22, a seat cushion unit 25 arranged on a top side of the vehicle frame unit 22 for an operator to sit thereon, and a power unit 26 supplying a power source to the vehicle 2.

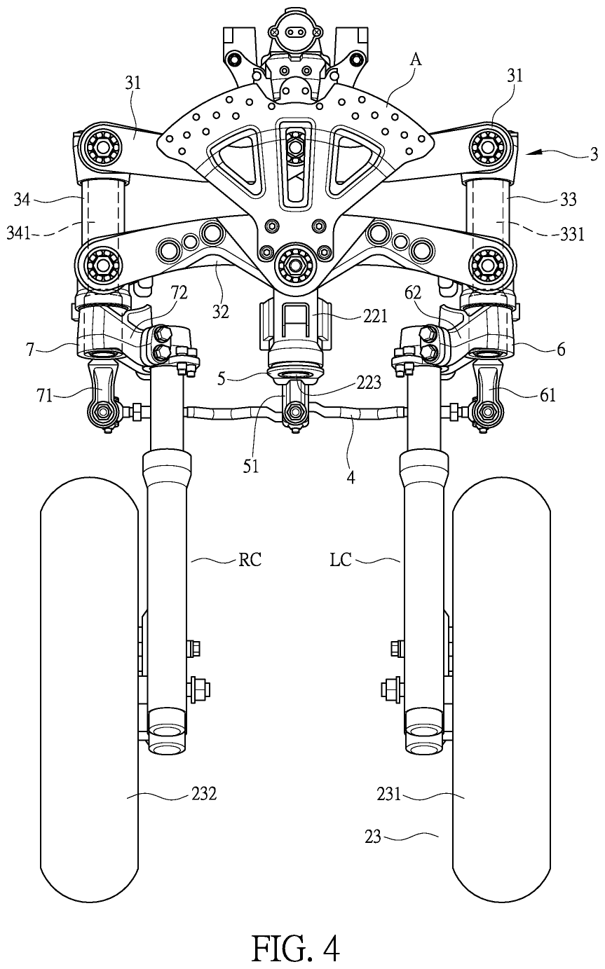

As shown in FIGS. 3 and 4, the vehicle frame unit 22 is provided, on a front side thereof (a direction toward a head of the vehicle 2 being the front side), with a support member 221 and a steering handlebar 222. A tilting mechanism 3 and a steering tie rod 4 are pivotally arranged on the support member 221. A steering axle 223 that is driven by the steering handlebar 222 is pivotally arranged on the support member 221. The steering axle 223 penetrates from a top side of the support member 221 into an interior of the support member 221, and a lower end of the steering axle 223 extends beyond a lower end of the support member 221. The portion of the steering axle 223 that extends out of the lower end of the support member 221 is provided with a central bearing member 5. The central bearing member 5 is connected to a central connection plate 51.

As shown in FIGS. 3 and 4, the tilting mechanism 3 comprises an upper crossbar section 31 pivotally connected to the support member 221, a lower crossbar section 32 pivotally connected to the support member 221 and located below the upper crossbar section 31, a left sidebar section 33 (a left hand side of an operator sitting on the vehicle referring to “left side”, and a right hand side being “right side”, this being applicable hereinafter) pivotally connected to the upper crossbar section 31 and the lower crossbar section 32, and a right sidebar section 34 pivotally connected to the upper crossbar section 31 and the lower crossbar section 32.

As shown in FIGS. 3 and 4, the upper crossbar section 31 of the tilting mechanism 3 is arranged in a pairwise form as a left one and a right one pivotally connected to the support member 221; more specifically, the left-and-right pair of the upper crossbar section 31 are pivotally connected, in a jointly fastened manner, to the support member 221, and the left-and-right pair of the upper crossbar section 31 are pivotally connected to the support member 221 in a coaxial manner in a front-rear direction of the vehicle 2; the upper crossbar section 31 is pivotally connected to upper portions of the left sidebar section 33 and the right sidebar section 34 in a pivoting manner in the front-rear direction of the vehicle 2.

As shown in FIGS. 3 and 4, the lower crossbar section 32 of the tilting mechanism 3 is made in a form of a frame and is pivotally connected to the support member 221 in a front-rear fashion. The lower crossbar section 32 is pivotally connected to the support member 221 in a coaxial manner in the front-rear direction of the vehicle 2. The lower crossbar section 32 is pivotally connected to lower portions of the left sidebar section 33 and the right sidebar section 34 in a pivoting manner in a vehicle body front-rear direction of the vehicle 2.

As shown in FIGS. 3 and 4, the left sidebar section 33 of the tilting mechanism 3 is pivotally connected, at an upper portion thereof, to the upper crossbar section 31, and has a lower portion pivotally connected to the lower crossbar section 32; the left sidebar section 33 receives a left-side axle 331 to extend therethrough in an interior thereof, and a lower end of the left-side axle 331 is connected to a left bearing member 6, and the left bearing member 6 is connected to a left connection plate 61 and a left connection bridge 62, and the left connection bridge 62 is connected to and supports a left shock absorber LC, and a lower end of the left shock absorber LC supports a left front wheel 231. The right sidebar section 34 of the tilting mechanism 3 is pivotally connected, at an upper portion thereof, to the upper crossbar section 31, and has a lower portion pivotally connected to the lower crossbar section 32; the right sidebar section 34 receives a right-side axle 341 to extend therethrough in an interior thereof, and a lower end of the right-side axle 341 is connected to a right bearing member 7, and the right bearing member 7 is connected to a right connection plate 71 and a right connection bridge 72, and the right connection bridge 72 is connected to and supports a right shock absorber RC, and a lower end of the right shock absorber RC support a right front wheel 232.

As shown in FIGS. 2, 3, and 4, the tilting mechanism 3 is formed as a generally parallelogram frame configuration by means of the upper crossbar section 31 pivotally connected to an upper portion of the support member 221, the lower crossbar section 32 pivotally connected to a lower portion of the support member 221, and the left sidebar section 33 of which upper and lower portions are respectively and pivotally connected to the upper crossbar section 31 and the lower crossbar section 32 and the right sidebar section 34 of which upper and lower portions are respectively and pivotally connected to the upper crossbar section 31 and the lower crossbar section 32. As such, the tilting mechanism 3 is allowed to do tilting oscillation by means of a motion of a parallelogram of the upper crossbar section 31, the lower crossbar section 32, the left sidebar section 33, and the right sidebar section 34.

As shown in FIGS. 3 and 4, the vehicle frame unit 22 is provided with a locking device A frontward of the support member 221 for preventing tilting of the tilting mechanism 3 in a parked condition.

As shown in FIGS. 2 and 3, the steering handlebar 222 of the vehicle frame unit 22 is provided on two sides thereof with primary switch mounts 27 (only the left side portion being visible in the drawings). The primary switch mounts 27 are provided for installation of a plurality of switches that control a change of a vehicle operating state or provide an indication of a change of a vehicle operating state. The switches that control a change of a vehicle operating state or provide an indication of a change of a vehicle operating state refer to a headlight control switch for controlling front lighting of the vehicle 2, directional sign control switches for indication of left and right turning of the vehicle 2, a starter motor control switch for starting the vehicle 2, a horn switch for warning other vehicles or pedestrians, and the likes, meaning when the operator attempts to change a vehicle operating state during running of the vehicle 2, the operator must personally operate the control switch at the moment; the vehicle frame unit 22 is provided with a main switch lock 28 that is arranged adjacent to the support member 221, faces toward a vehicle body rear side, and is at a front side of the seat cushion unit 25, and the main switch lock 28 is electrically connected to a battery (not shown in the drawings) that functions as a main power supply of the vehicle 2, so that controlling the main switch lock 28 may control energization of all electrical components of the vehicle 2. The main switch lock 28 also functions to control the steering handlebar 222 for free rotation or not.

As shown in FIGS. 2 and 3, the vehicle-body cover unit 21 at least comprises a front vehicle-body cover 211 arranged on and covering a frontmost portion of the vehicle 2 and a knee-shielding hood 212 arranged on and covering a rear side of the steering support member 221. The front vehicle-body cover 211 and the knee-shielding hood 212, after being combined, form a cover that encloses the support member 221, the tilting mechanism 3, and the locking device A; the vehicle-body cover unit 21 includes side vehicle-body covers 213 arranged from the knee-shielding hood 212 toward the vehicle body rear side and covering two sides of the vehicle body, and rear vehicle-body covers 214 from the side vehicle-body covers 213 further toward the vehicle body rear side to cover two sides of the vehicle body rear side; the seat cushion unit 25 is arranged on the top side of the vehicle frame unit 22 between the two side vehicle-body covers 213.

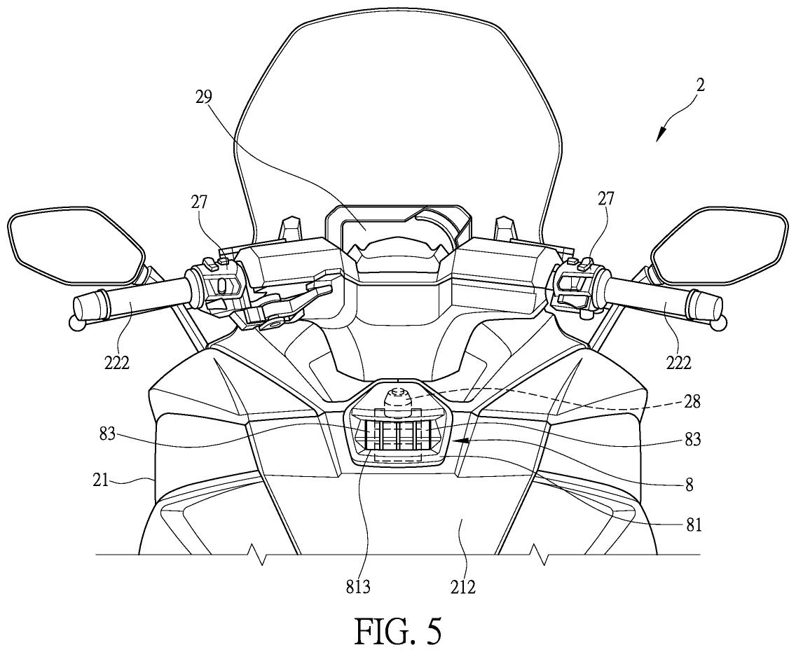

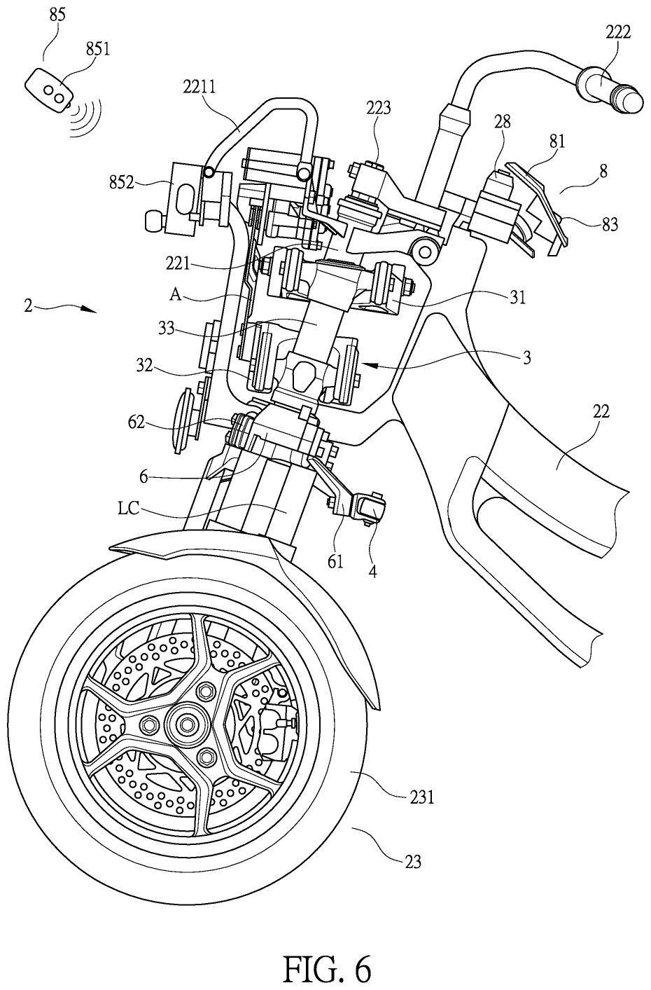

As shown in FIGS. 3, 5, 6, and 8, the vehicle 2 is provided with a secondary switch mount 8 for installation of switches for changing a vehicle operating state in a non-running condition or providing an indication of a change of a vehicle-operating state, and the secondary switch mount 8 is fastened and fixed on the knee-shielding hood 212, and is located on a side of the support member 221 of the vehicle frame unit 22 toward the vehicle body rear side, and a front end of the secondary switch mount 8 (in a direction toward the vehicle body front side) and the main switch lock 28 form a partly overlapping arrangement, meaning when viewed in the front-rear direction of the vehicle body, the main switch lock 28 is located in a projection range of the secondary switch mount 8, so that the secondary switch mount 8 is located at a front side of the seat cushion unit 25, and the operator, when sitting down on the seat cushion unit 25, may conveniently operate the secondary switch mount 8.

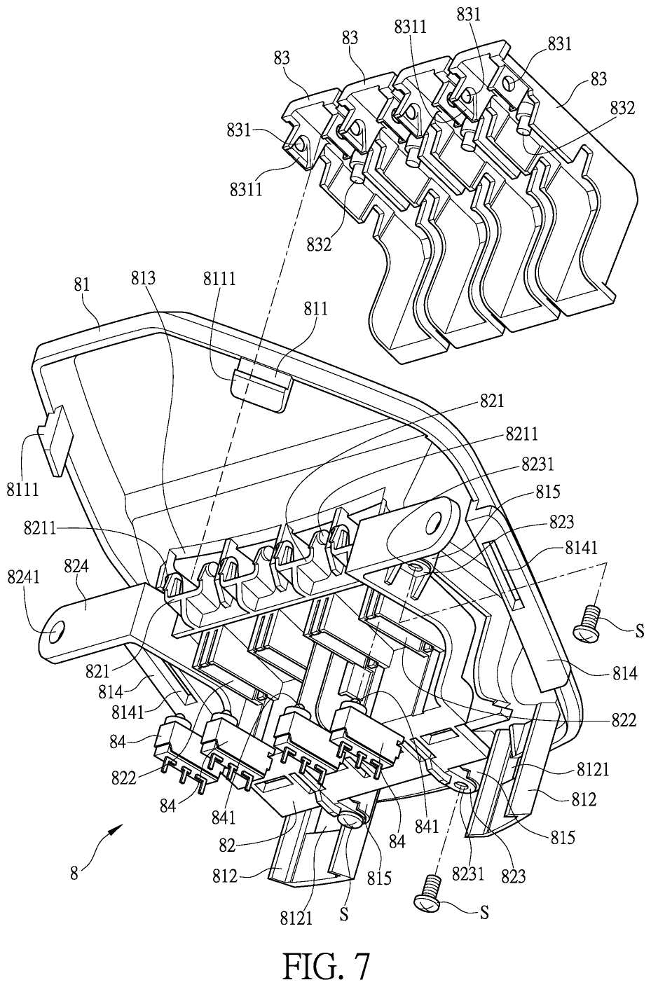

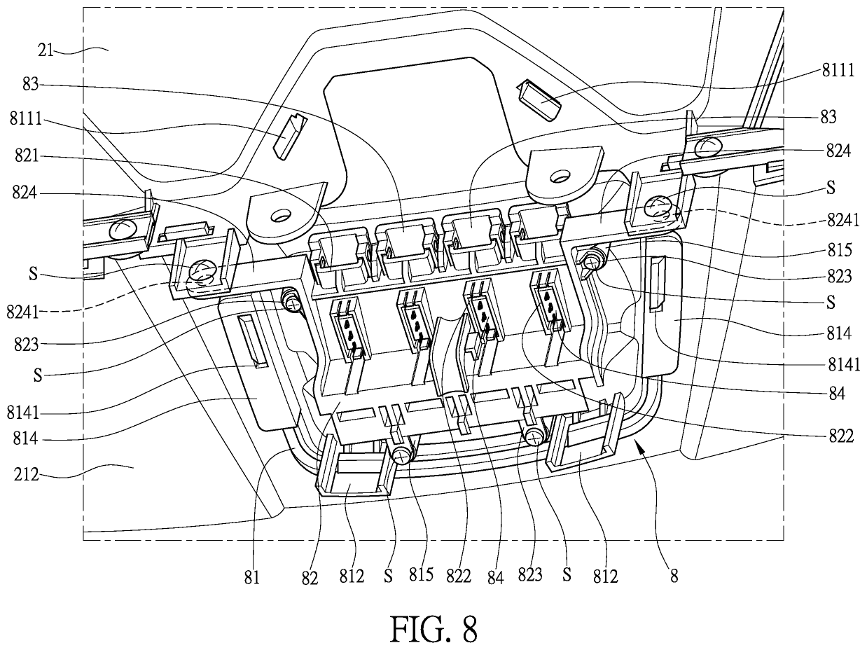

As shown in FIGS. 7 and 8, the secondary switch mount 8 comprises a main-body mount 81 and a fixing-frame mount 82 mounted on the main-body mount 81, and a plurality of switch control buttons 83 and trigger switches 84 arranged on the fixing-frame mount 82; a front end of the main-body mount 81 is provided with hooking ribs 811, and the main-body mount 81 is provided, on an end opposite to the hooking ribs 811, with retaining ribs 812, and the main-body mount 81 is provided with a penetrating-through mounting-hole section 813 between the hooking ribs 811 and the retaining ribs 812, and the main-body mount 81 is provided with fitting ribs 814 alongside outer edges at sides of the mounting-hole section 813; the hooking ribs 811 comprise a hook section 8111, and the hooking ribs 811 are arranged pairwise as a left one and a right one on the front end of the main-body mount 81, and the retaining ribs 812 comprise a retaining hole 8121, and the retaining ribs 812 are arranged pairwise as a left one and a right one on a rear end of the main-body mount 81, and the fitting ribs 814 comprise a fitting hole 8141, so that the main-body mount 81 is mountable to and fixed to the knee-shielding hood 212 by means of hooks of the hooking ribs 811 fitting into and engaging with the retaining ribs 812 and fitting of the fitting ribs 814, and more specifically, the main-body mount 81 and the knee-shielding hood 212 is provided with hooking engagement of the hooking ribs 811 at the front end, fitting of the fitting ribs 814 in the middle, and fitting and retaining of the retaining ribs 812 at the rear end, so as to possess connection fixing arrangements at three sites to allow the main-body mount 81 to be securely positioned on the knee-shielding hood 212; four corners of the mounting-hole section 813 are respectively provided with fastening pegs 815 extended from the main-body mount 81.

As shown in FIGS. 7 and 8, the fixing-frame mount 82 comprises a plurality of pivoting sections 821 and fitting troughs 822, and the pivoting sections 821 receive the switch control buttons 83 to pivotally connect thereto, and in the present invention, a push-down fashion is taken as an example for implementing the switch control buttons 83, and an arrangement of four pivoting sections 821 is provided as an example for description, and consequently, an example in which four switch control buttons 83 are shown in the drawings is provided as an example for illustration; the pivoting sections 821 comprise pivot pins 8211 projecting therefrom, and the switch control buttons 83 comprise pivot holes 831, so that the pivot pins 8211 are received through the pivot holes 831 to allow the switch control buttons 83 to pivotally mount, in a manner of being in a left-right width direction of the vehicle body, to the pivoting sections 821 of the fixing-frame mount 82 of the secondary switch mount 8, and thus, the switch control buttons 83 are allowed to freely oscillate upward and downward in an up-down direction of the vehicle body about an oscillation center defined by the pivot pins 8211, meaning the switch control buttons 83 is operated in a manner of being depressible down in the up-down direction of the vehicle body; the switch control buttons 83 are provided with curved guide slots 8311 that are arranged around a periphery of the pivot hole 831 in an outward diverging form; the switch control buttons 83 are provided with a trigger peg 832 projecting therefrom adjacent to the pivot hole 831; the fitting troughs 822 are located on a rear side of the pivoting sections 821, and as an example for illustrating the present invention, four fitting troughs 822 are provided; the fitting troughs 822 receive the trigger switches 84 to fit and position therein, and the trigger switches 84 comprise a trigger section 841, and the trigger sections 841 respectively correspond to the trigger pegs 832 of the switch control buttons 83, so that the operator pressing down the switch control buttons 83 would cause the trigger pegs 832 to contact and depress the trigger sections 841 of the trigger switches 84 to thereby energize the trigger switches 84 for operation; four corners of the fixing-frame mount 82 are provided with fastening lugs 823 that respectively correspond to the fastening pegs 815 of the main-body mount 81, and the fastening lugs 823 comprise a fastening aperture 8231, so that fastening elements S are applicable to the fastening apertures 8231 of the fastening lugs 823 for fastening to the fastening pegs 815 of the main-body mount 81, so that the fixing-frame mount 82 is fastened to the main-body mount 81; the fixing-frame mount 82 is provided, on two sides thereof, with fixing lugs 824 projecting therefrom, and the fixing lugs 824 are formed with fixing holes 8241, so that fastening elements S are applicable to the fixing holes 8241 of the fixing lugs 824 for forming fastened connection of the sides of the fixing-frame mount 82 to the knee-shielding hood 212; it is noted that the fixing-frame mount 82 is connected, through fastening by means of the fastening lugs 823, to the main-body mount 81, and is also fastened and connected by means of the fixing lugs 824 to the knee-shielding hood 212, so that the fixing-frame mount 82 may maintain a certain level of supporting stiffness strength after being formed with the pivoting sections 821 and the fitting troughs 822.

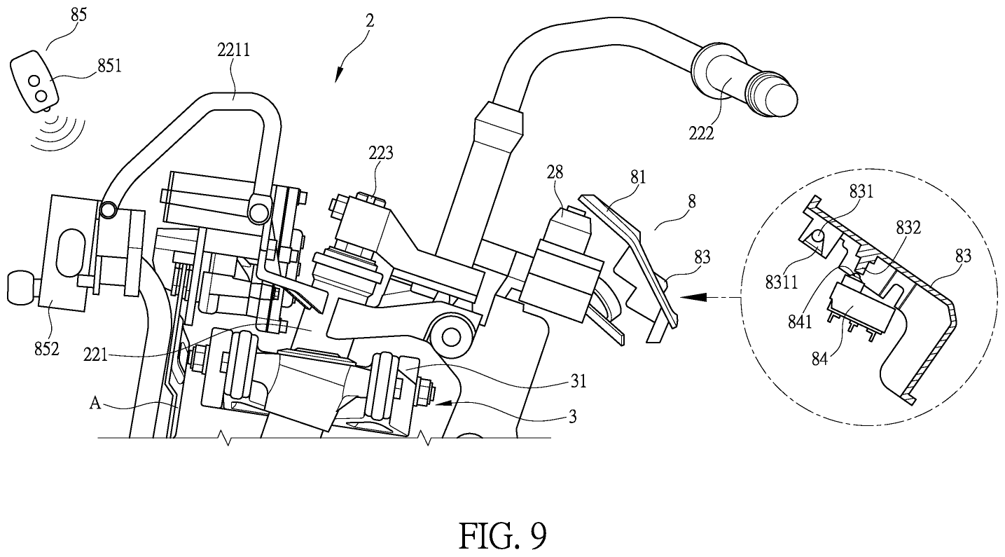

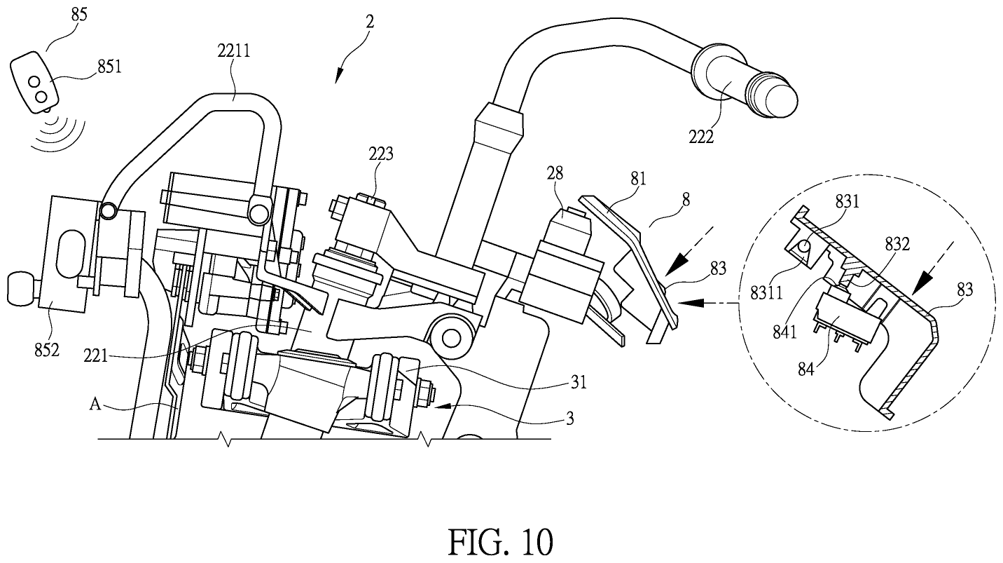

As shown in FIGS. 3, 5, 6, 7, 8, 9, and 10; the trigger switches 84 is electrically connected to the main power supply batter of the vehicle 2, and the trigger switches 84 are provided with the trigger sections 841, so that when the operator presses down the switch control buttons 83, the trigger pegs 832 of the switch control buttons 83 get contacting and depressing the trigger sections 841 of the trigger switches 84, so as to conduct electricity to the trigger switches 84 for activation, and the trigger switches 84, when triggered and activated, may control a control item for a change of a non-vehicle-operating state of the vehicle 2, such as controlling a seat cushion lock 251 for opening the seat cushion unit 25 or not, switching options for displaying different screens on a display of a dashboard 29, contents of the dashboard 29 (adjusting mileages), the main switch lock 28 releasing locking of the steering handlebar 222, and the likes; the secondary switch mount 8 is further provided with a wireless control mechanism 85, and the wireless control mechanism 85 comprises a sensor 851 that is portably carried by the operator and a controller 852 detectable by the sensor 851 for activation.

As shown in FIGS. 3, 5, 6, 9, and 10, the controller 852 of the wireless control mechanism 85 is arranged on a connecting frame 2211 extending from the support member 221 of the vehicle frame unit 22 toward the front side of the vehicle body, so that the controller 852 is securely fixed on the front side of the vehicle body of the vehicle 2 by means of the connecting frame 2211, and further, the controller 852 is located frontward of the tilting mechanism 3, and the controller 852 located on the vehicle body front side can be shielded by the front vehicle-body cover 211, so that the controller 852 features bettered concealability for protection against attack by external moisture and dust, and it is noted that there is only the front vehicle-body cover 211 that is made of a plastic material located at the front side of the controller 852, so that the controller 852 may be enhanced in respect of an effect of detection thereof due to being not shielded by metals; the controller 852 is electrically connected to the battery and the plurality of trigger switches 84, meaning when the controller 852 is detected by the sensor 851 and thus activated for operation, it may enter a standby condition according to the state of energization of the plurality of trigger switches 84, and under such a condition, the operator may selectively press down the switch control buttons 83 according to the item that is to be controlled, so as to have the trigger switches 84 that correspond to the switch control buttons 83 to fulfill the purpose of controlling a desired control item.

Primary efficacy of the present invention resides on that a front end of a vehicle frame unit 22 of a vehicle 2 is provided with a support member 221, and the support member 221 is provided with a steering handlebar 222, and two sides of the steering handlebar 222 are each provided with a primary switch mount 27; an outer periphery of the vehicle frame unit 22 is provided with and covered by a vehicle-body cover unit 21, and the vehicle-body cover unit 21 at least comprises a knee-shielding hood 212, and the knee-shielding hood 212 of the support member 221 that is arranged toward a vehicle body rear side is provided with a secondary switch mount 8, and the secondary switch mount 8 comprises a plurality of switch control buttons 83 and a plurality of trigger switches 84 that are triggerable by the switch control buttons 83; and as such, a control item for a change of a non-vehicle-operating state of the vehicle 2 is controlled to thereby enhance operation performance of the vehicle 2.

I claim:

1. A control switch mount structure of a straddling fashion vehicle, wherein a front end of a vehicle frame unit of a vehicle is provided with a support member, the support member being provided with a steering handlebar, two sides of the steering handlebar being each provided with a primary switch mounts; and an outer periphery of the vehicle frame unit is provided with and covered by a vehicle-body cover unit, the vehicle-body cover unit at least comprising a knee-shielding hood, and characterized in that the knee-shielding hood of the support member that is arranged toward a vehicle body rear side is provided with a secondary switch mount, the secondary switch mount comprising plurality of switch control buttons and a plurality of trigger switches that are triggerable by the switch control buttons.

2. The control switch mount structure of the straddling fashion vehicle according to claim 1, wherein the secondary switch mount further comprises a wireless control mechanism, and the wireless control mechanism comprises a sensor and a controller.

3. The control switch mount structure of the straddling fashion vehicle according to claim 2, wherein the controller is arranged on a connecting frame extended from the support member.

4. The control switch mount structure of the straddling fashion vehicle according to claim 1, wherein the support member is provided thereon with a tilting mechanism, the tilting mechanism comprising an upper crossbar section pivotally connected to the support member, a lower crossbar section pivotally connected to the support member and located below the upper crossbar section, a left sidebar section pivotally connected to the upper crossbar section and the lower crossbar section, and a right sidebar section pivotally connected to the upper crossbar section and the lower crossbar section.

5. The control switch mount structure of the straddling fashion vehicle according to claim 4, wherein the support member is further provided with a locking device that is operable to lock the tilting mechanism.

6. The control switch mount structure of the straddling fashion vehicle according to claim 1, wherein the switch control buttons are pivoted to the secondary switch mount in a manner of being in a vehicle body left-right width direction.

7. The control switch mount structure of the straddling fashion vehicle according to claim 1, wherein the vehicle frame unit is provided with a main switch lock, and when viewed in a vehicle body front-rear direction, the main switch lock is located in a projection region of the secondary switch mount.

8. The control switch mount structure of the straddling fashion vehicle according to claim 1, wherein the secondary switch mount comprises a main-body mount and a fixing-frame mount arranged on the main-body mount, the main-body mount comprising a mounting-hole section, the fixing-frame mount being mounted to the mounting-hole section; the fixing-frame mount is provided with at least one pivoting section and at least one fitting trough; and the switch control buttons are arranged on the pivoting section, and the trigger switches are arranged in the fitting trough.

9. The control switch mount structure of the straddling fashion vehicle according to claim 8, wherein the pivoting section of the fixing-frame mount comprises a pivot pin, and the switch control buttons comprise a pivot hole, and the switch control buttons is pivoted to the pivot pin of the pivoting section by means of the pivot hole; the switch control buttons further comprise a trigger peg, and the trigger switches comprise a trigger section corresponding to the trigger peg of the switch control buttons.

10. The control switch mount structure of the straddling fashion vehicle according to claim 8, wherein
the main-body mount further comprises hooking ribs, retaining ribs, and fastening pegs; the fixing-frame mount comprise fastening lugs and fixing lugs; the main-body mount is fixed to the knee-shielding hood by means of the hooking ribs and the retaining ribs; the fixing-frame mount are fastened to the fastening pegs of the main-body mount by means of the fastening lugs; and the fixing-frame mount is fixed to the knee-shielding hood by means of the fixing lugs.

11. The control switch mount structure of the straddling fashion vehicle according to claim 9, wherein
the main-body mount further comprises hooking ribs, retaining ribs, and fastening pegs; the fixing-frame mount comprise fastening lugs and fixing lugs; the main-body mount is fixed to the knee-shielding hood by means of the hooking ribs and the retaining ribs; the fixing-frame mount are fastened to the fastening pegs of the main-body mount by means of the fastening lugs; and the fixing-frame mount is fixed to the knee-shielding hood by means of the fixing lugs.
